(19) United States
(12) Patent Application Publication
(10) Pub. No.: US 2005/0104357 A1
(43) Pub. Date: May 19, 2005

(54) Clothing protection sleeve

(76) Inventor: Pamela Olson, Chattanooga, TN (US)

Correspondence Address: HUSCH & EPPENBERGER, LLC, 190 CARONDELET PLAZA, SUITE 600, ST. LOUIS, MO, 63105-3441, US

(21) Appl. No.: 10/715,900

(22) Filed: Nov. 18, 2003

(51) Int. Cl. B60R 22/00; B60R 22/48

(52) U.S. Cl. 280/801.1

(57) ABSTRACT

A clothing protection sleeve for a vehicle seat belt includes a rectangular piece of fabric having an inside surface and an outside surface; a layer of quilted, friction-minimizing material attached to the outside surface of the piece of fabric; and a hook and loop fastening system, whereby the rectangular piece of fabric is wrapped around the seat belt with the quilted, friction-minimizing material facing outward and secured with the hook and loop fasteners.

### CROSS-REFERENCES

This application claims the priority of provisional application Ser. No. 60/427,237, filed Nov. 18, 2002.

### TECHNICAL FIELD OF THE INVENTION

This invention generally relates to clothing protection and, more particularly, to a cover for vehicle seat belts to protect the seat occupant's clothing.

### DESCRIPTION OF THE RELATED ART

The majority of states now require at least the front seat occupants of automobiles to utilize seat belts while the vehicle is being driven. Furthermore, the vast majority of automobiles on the road today utilize seat belts having shoulder harnesses in addition to lap belts. Seat belts, and in particular the shoulder harness portion of seat belts, have a propensity to damage the occupant's clothing. This damage can be caused by the friction created between the belt and the occupant's clothing, resulting in premature aging of the fabric. The damage can also be caused by the rough edges of the belt snagging clothing and creating runs in the fabric. Also, because seat belts are cleaned extremely infrequently, they often become covered with dirt, grease and other troublesome substances that can quickly be transferred to and ground into an occupant's clothing.

While frequent cleaning of a vehicle's seat belts could help prevent some of these problems, it is often impractical for a vehicle owner to do so due to time constraints. Devices designed to cover seat belts and isolate the belts have been designed. However, these devices interfere with the seat belt's ability to fully and freely retract when not in use and do little to minimize the level of friction between the belt/cover and the occupant's clothing, a major source of damage.

The present invention is directed to overcoming one or more of the problems set forth above.

### SUMMARY OF THE INVENTION

An aspect of the present invention is to provide an apparatus capable of minimizing the damage caused to the clothing of an occupant of a vehicle seat by a seat belt by isolating the belt from the occupant's clothing and minimizing friction between the clothing and the seat belt.

Another aspect of the present invention is to provide an apparatus for protection of a vehicle seat occupant's clothing that does not interfere with the operation of the seat belt, in particular, with the full and free retraction of the belt when not in use.

In accordance with the above aspect of the invention, there is provided a clothing protection sleeve for a vehicle seat belt that includes a rectangular piece of fabric having an inside surface and an outside surface; a layer of quilted, friction-minimizing material attached to the outside surface of the piece of fabric; and a hook and loop fastening system, whereby the rectangular piece of fabric is wrapped around the seat belt with the quilted, friction-minimizing material facing outward and secured with the hook and loop fasteners.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1A illustrates the outside surface of a clothing protection sleeve according to an embodiment of the present invention.

FIG. 1B illustrates the inside surface of the clothing protection sleeve of FIG. 1A.

FIG. 2 is a schematic view of a clothing protection sleeve according to an embodiment of the present invention as used by an occupant of a vehicle seat.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

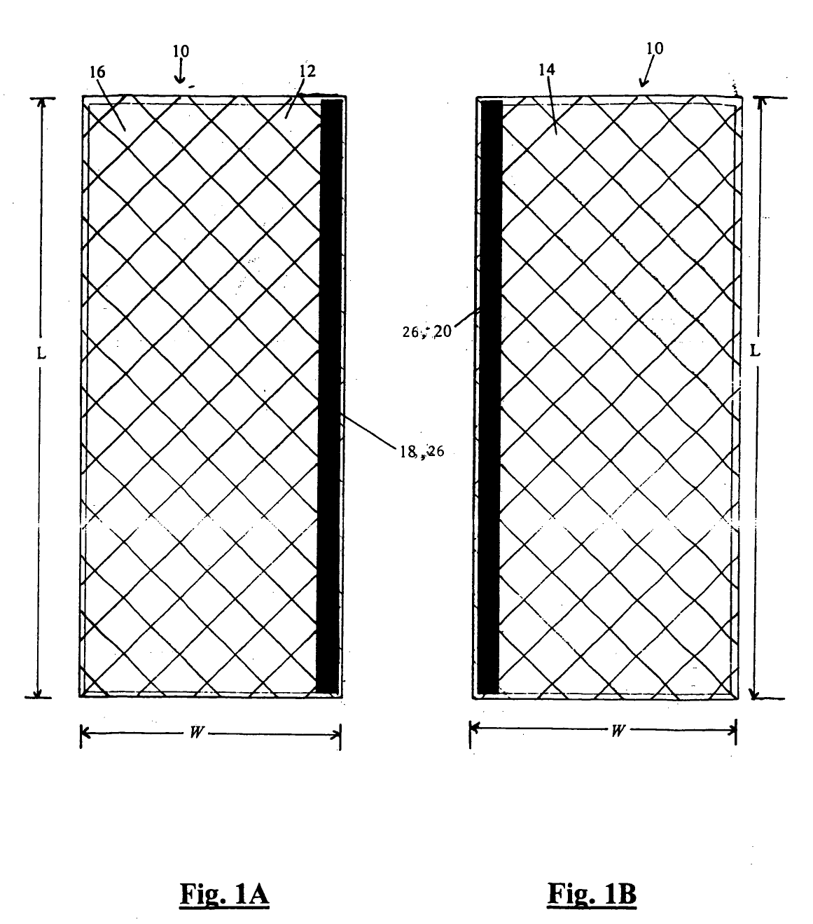

FIGS. 1A and 1B illustrate a clothing protection sleeve according to one embodiment of the invention. A rectangular piece of fabric 10 forms the base of the product. The piece of fabric may be of any suitable size as long as the width W of the piece of fabric is sufficient to wrap entirely around a standard vehicle seat belt with some overlap and the length L is sufficient to extend along a suitable length of the seat belt. Advantageously, the length L is sufficient for the fabric 10 to cover the majority of a shoulder belt. In the embodiment shown, the width W is approximately 9 inches and the length L is approximately 20.5 inches. These measurements merely represent one embodiment suitable for a variety of seat belts.

The rectangular piece of fabric 10 is provide with an outside surface 12 and inside surface 14. When the sleeve is installed on a seat belt, the inside surface 14 is adjacent to the surface of the seat belt, while the outside surface 12 faces outward from the seat belt and is adjacent to an occupant's clothing. The outside surface 12 is provided with a layer of quilted, friction-minimizing material 16. This material 16 allows the seat belt to slide freely across the occupant's clothing without snagging, smearing or otherwise damaging the clothing. The material 16 may be silk, satin, acetate or any other smooth-faced material.

The embodiment shown in FIGS. 1A and 1B includes a means to secure the fabric 10 around a seat belt in the form of a separable hook and loop fastener, such as Velcro® strips. A strip of hooks 18 is positioned along one length of the outside surface of the rectangular piece of fabric 10. A strip of loops 20 is positioned on the inside surface along the opposite length of the fabric 10. When the sleeve is installed on a seat belt, the hook strip 18 mates with the loop strip 20 to secure the sleeve in place around the belt. The embodiment shown in FIGS. 1A and 1B includes hook and loop strips that extend along the entire length of the fabric 10. However, in an equally suitable alternate embodiment there is provided a plurality of shorter hook and loop strips spaced along the length of the fabric 10. In another alternate embodiment, one side of a zipper 26 is attached to the outside surface of the fabric 10 while the opposite side of the zipper 26 is attached to the inside surface of the opposite length of the fabric 10. The fabric 10 may also be secured to the seat belt by means of laces.

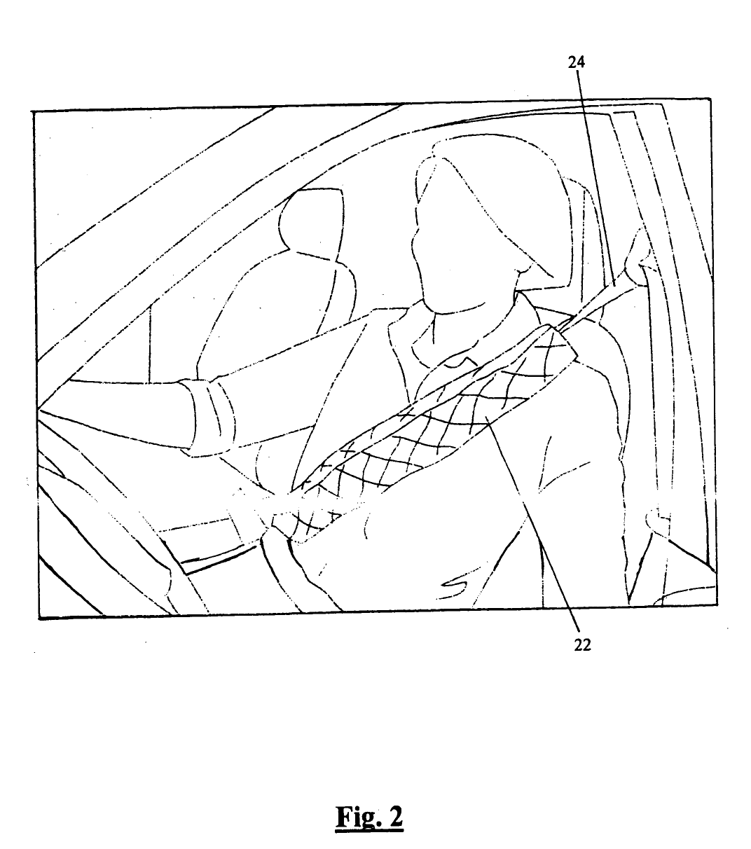

FIG. 2 illustrates a clothing protection sleeve 22 according to one embodiment of the invention in use in a vehicle. The sleeve is installed in the vehicle by wrapping the fabric 10 around a shoulder harness 24 of a seat belt with the quilted, friction-minimizing material facing outward and securing the fabric 10 around the shoulder harness 24 by mating the hook strip 18 with the loop strip 20. In a preferred embodiment, the length L of the sleeve 22 is sufficient to encompass most of the length of the shoulder harness 24, thereby minimizing sliding of the sleeve 22 either up or down the shoulder harness 24. While the embodiment shown in FIG. 2 illustrates a clothing protection sleeve installed on a shoulder harness, the sleeve may also be used to cover a lap belt. When the user disembarks from the vehicle and removes the seat belt, the sleeve 22 collapses as the seat belt retracts, thereby allowing full and free retraction of the seat belt for storage.

Other objects, features and advantages of the present invention will be apparent to those skilled in the art. While preferred embodiments of the present invention have been illustrated and described, this has been by way of illustration and the invention should not be limited.

1. A protective sleeve for a vehicle shoulder safety belt comprising:
a generally rectilinear piece of material, said material having an outer surface and an inner surface, said outer surface including a quilted, friction-minimizing material;
said rectilinear piece of material having a width of sufficient dimension to wrap entirely around a standard vehicle shoulder safety belt and a length of sufficient dimension to cover a majority of said vehicle shoulder safety belt when the safety belt is extended;
a first strip of self-fastening material attached to the outer surface; and
a second strip of self-fastening material attached to the inner surface.

2. A protective sleeve as set forth in claim 1, wherein said first strip of self-fastening material comprises a strip of hooks and wherein said second strip of self-fastening material comprises a strip of loops.

3. A protective sleeve as set forth in claim 1, wherein the quilted, friction-minimizing material is selected from the group consisting of silk, satin, and acetate.

4. A protective sleeve as set forth in claim 1, wherein said first strip of self-fastening material comprises a first half of a zipper and said second strip of self-fastening material comprises a second half of a zipper.

5. A method protecting a person's clothing while wearing a vehicle shoulder safety belt, comprising the steps of:
providing a generally rectilinear piece of material, said material having an outer surface and an inner surface and a width of sufficient dimension to wrap entirely around a standard vehicle shoulder safety belt, said outer surface including a quilted, friction-minimizing material;
wrapping said rectilinear piece of material around said vehicle shoulder safety belt with said quilted, friction-minimizing material facing outward; and
connecting a first strip of self-fastening material attached to the outer surface of the rectilinear piece of material with a second strip of self-fastening material attached to the inner surface of the rectilinear piece of material to secure the rectilinear piece of material around the vehicle shoulder safety belt.

6. A method protecting a person's clothing while wearing a vehicle shoulder safety belt as set forth in claim 5, further comprising the steps of:
extending said vehicle shoulder safety belt prior to wrapping the rectilinear piece of material around said vehicle shoulder safety belt;
retracting said vehicle shoulder safety belt after wrapping said rectilinear piece of material around said vehicle shoulder safety belt;
re-extending said vehicle shoulder safety belt with said rectilinear piece of material after said person is situated in the vehicle; and
re-retracting said vehicle shoulder safety belt with said rectilinear piece of material before said person exits the vehicle.

7. A method protecting a person's clothing while wearing a vehicle shoulder safety belt as set forth in claim 5, wherein said step of connecting first and second strips of self-fastening material includes connecting a strip of hooks to a strip of loops.

8. A protective sleeve for a vehicle shoulder safety belt to minimize damage and wear to an occupant's clothing comprising:
a generally rectilinear piece of material, said material having an outer surface and an inner surface, said outer surface including a quilted, friction-minimizing material selected from the group consisting of silk, satin, and acetate;
said rectilinear piece of material having a width of sufficient dimension to wrap entirely around a standard vehicle shoulder safety belt and a length of sufficient dimension to cover a majority of said vehicle shoulder safety belt when the safety belt is extended;
a first strip of self-fastening hooks attached to the outer surface; and
a second strip of self-fastening loops attached to the inner surface.
